(19) United States
(12) Patent Application Publication
(10) Pub. No.: US 2015/0063902 A1
(43) Pub. Date: Mar. 5, 2015

(54) MOUNTING UNIT AND METHOD FOR ITS PRODUCTION

(71) Applicant: RICHARD BERGNER VERBINDUNGSTECHNK GMBH & CO.KG, Schwabach (DE)

(72) Inventor: WILHELM SCHNEIDER, REDNITZHEMBACH (DE)

(21) Appl. No.: 14/471,185

(22) Filed: Aug. 28, 2014

(30) Foreign Application Priority Data
Aug. 28, 2013 (DE) 102013014231.8

(51) Int. Cl. B62D 27/02; B23P 17/04; B62D 24/00; B21D 53/88

(52) U.S. Cl. CPC B62D 27/02; B21D 53/88; B23P 17/04; B62D 24/00
USPC 403/266; 29/897.2

(57) ABSTRACT

A mounting unit has a mounting part with a mounting face and an outer face facing away therefrom. The mounting part is configured for fixing to a basic structure made of a material which is not able to be welded to the material of the mounting part. The mounting part further has a welding sleeve fixed in a through-bore of the mounting part. An outer end of the sleeve is arranged on the outer face and bears a radially protruding flange supported on the outer face of the mounting part. A shaft of the sleeve protruding from a flange lower face has a contour shape corresponding to the cross-sectional shape of the through-bore and a length which is at least as large as a thickness of the mounting part in the edge region of the hole of the through-bore. The shaft is retained in the through-bore by a form-locking connection.

The invention relates to a mounting unit having a mounting part and a welding element as well as a method for producing the mounting unit.

The fixing of a mounting part, for example a sheet metal-like body part to a basic structure of a motor vehicle, frequently takes place by point welding or resistance welding. In particular in automobile construction, mounting parts made of light-weight materials such as aluminum are used, for example, for weight saving reasons. If in this case a mix of materials is produced which is not able to be welded, i.e. if the material of the mounting part may not be welded to the material of the basic structure, the mounting part is provided with one or more welding elements which consist of a material which is compatible in terms of welding technology with the material of the basic structure, for example steel. The welding element is fixed in a through-bore of the mounting part, wherein the mounting part has a mounting face and an outer face facing away therefrom. If the mounting unit and/or the mounting part is fixed to a surface of the basic structure denoted hereinafter as the mating surface, the mounting face faces this mating surface.

In conventional connections of the type under discussion, disclosed for example in WO 2012/041515 A1, a disk-shaped welding element is provided, said welding element being inserted by a positive and/or non-positive connection in the through-bore of the mounting part. The welding element, configured as a disk substantially completely filling up the through-bore, has a relatively large mass which, in particular, with thick mounting parts has a negative effect on the total weight of the mounting unit. The weight saving achieved by the use of a light-weight mounting part is at least partially compensated as a result. Moreover, welding elements and/or welding element blanks of variable thicknesses corresponding to the thickness of the mounting part have to be used.

Proceeding therefrom, it is the object of the invention to propose a mounting unit in which the use of welding elements of reduced weight is possible without compromising the strength of the connection between the mounting unit and the welding element. Moreover, the welding elements in their initial form, i.e. the welding element blanks, are intended to be able to be produced easily and able to be used for a wide range of thicknesses of the mounting parts.

The object of the invention is also to specify a method for producing the mounting unit which may be carried out easily.

The first object is achieved by a mounting unit as claimed in claim 1 and the second object by a method as claimed in claim 14.

A mounting unit according to the invention comprises at least one welding element configured as a sleeve, wherein the outer end of the sleeve arranged on the outer face of the mounting part bears a radially protruding flange. Said flange is supported with at least one part of its flange lower face on the outer face of the mounting part. By means of this design a positive connection is ensured between the welding element and the mounting part in a direction extending toward the outer face.

The part of the sleeve extending away from the flange, i.e. the shaft thereof protruding from the flange lower face, has a length which is at least as great as the thickness of the mounting part in the edge region of the hole of the through-bore. The inner end of the shaft arranged on the mounting face, therefore, terminates flush with the mounting face of the mounting part or protrudes beyond said mounting face with a set overhang. A front face present on the inner end of the shaft which serves as a welding surface for welding to the mating surface of the basic structure may, therefore, be brought into contact with the mating surface of the basic structure for the purpose of producing a welded connection.

The shaft of the sleeve has a contour shape corresponding to the cross-sectional shape of the through-bore, whereby the production of a positive connection and/or frictional connection between the wall of the through-bore and the outer wall of the shaft, for example by a radial widening of the shaft, is facilitated.

The shaft is retained in the through-bore by a further positive connection and namely by a positive connection in a direction facing toward the mounting face. The welding element in this case is able to be fixed in the through-bore of the mounting part with the strength required for the subsequent fixing of the mounting unit to the basic structure. The mounting unit, therefore, may be transported without the risk of the loss of a welding element. Moreover, the subsequent mounting on a basic structure is facilitated in that the mounting unit does not first have to be provided with welding elements which might be associated with a corresponding cost in terms of logistics and technical process.

By the sleeve-like design of the welding element, the quantity of material thereof and accordingly the weight thereof are reduced relative to a disk-shaped welding element practically completely filling the through-bore of the mounting part. The strength of the welded connection in this case is, however, comparable with a disk-shaped welding element which is connected by a central welding zone to the basic structure, or is even greater. Firstly, a sufficiently large welding surface is available with the annular front face. Secondly, relative to a central punctiform welding surface and/or welding zone a greater resistance of the welded connection results with regard to tilting of the mounting part relative to the central longitudinal axis of the welding element and/or the through-bore. In other words, in the proposed connection, a greater pull-through force may be transmitted as the welding element at the connecting point with the mounting part is subjected only to shear stress and not additionally to bending stress.

In the method according to the invention for producing the mounting unit, a sleeve is provided as a welding element blank which bears at its one end a radially protruding flange, wherein the shaft of the sleeve protruding from the flange lower face has a contour shape corresponding to the cross-sectional shape of the through-bore and a length which is at least as great as the thickness of the mounting part in the edge region of the hole. The welding element blank is thus introduced into the through-bore such that the flange bears against the outer face of the mounting part and the inner end of the shaft on the mounting side is aligned with the mounting face or protrudes therefrom with an overhang. A further advantage of the sleeve-like design of the welding element is that it may be connected positively to the mounting part in a simple manner by means of a punch supplied from the mounting face. To this end, at least one partial region of the sleeve shaft extending away from the welding surface is radially widened and at the same time is plastically deformed, creating a positive connection between the shaft and the mounting part in a direction extending away from the mounting face and toward the flange.

The invention together with further advantageous embodiments is now described in more detail with reference to the accompanying drawings, in which (primarily in sectional view):

FIG. 1A shows a first exemplary embodiment of a mounting unit which comprises a mounting part penetrated by a through-bore and a sleeve-like welding element inserted into the through-bore,

FIG. 1B shows a plan view in the direction of the arrow IB of FIG. 1A,

FIGS. 2A-D show the production of the mounting unit of FIG. 1A based on a welding element blank and a mounting part,

FIG. 3 show the detail III of FIG. 1A which shows a first variant of the positive connection between the welding element and the mounting unit,

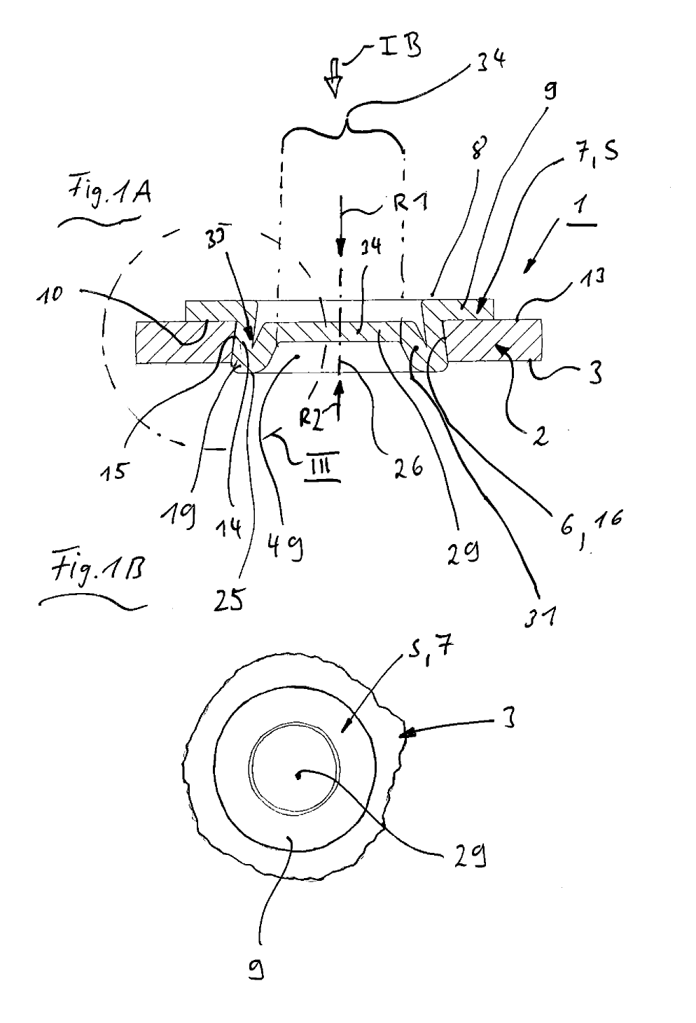

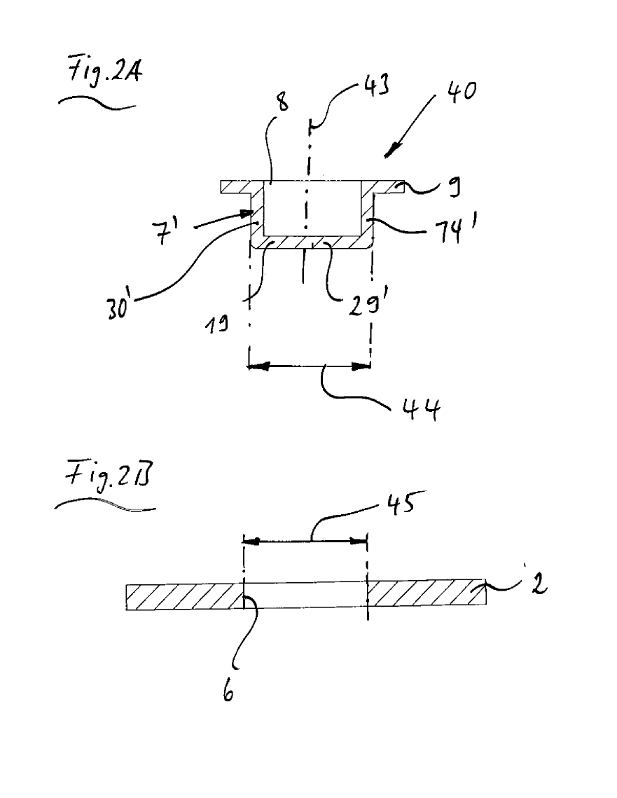

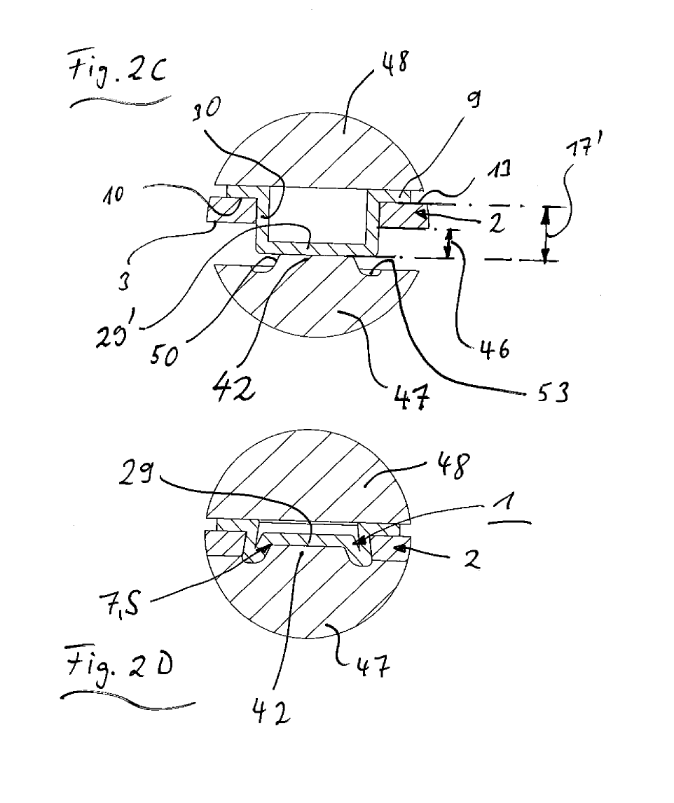

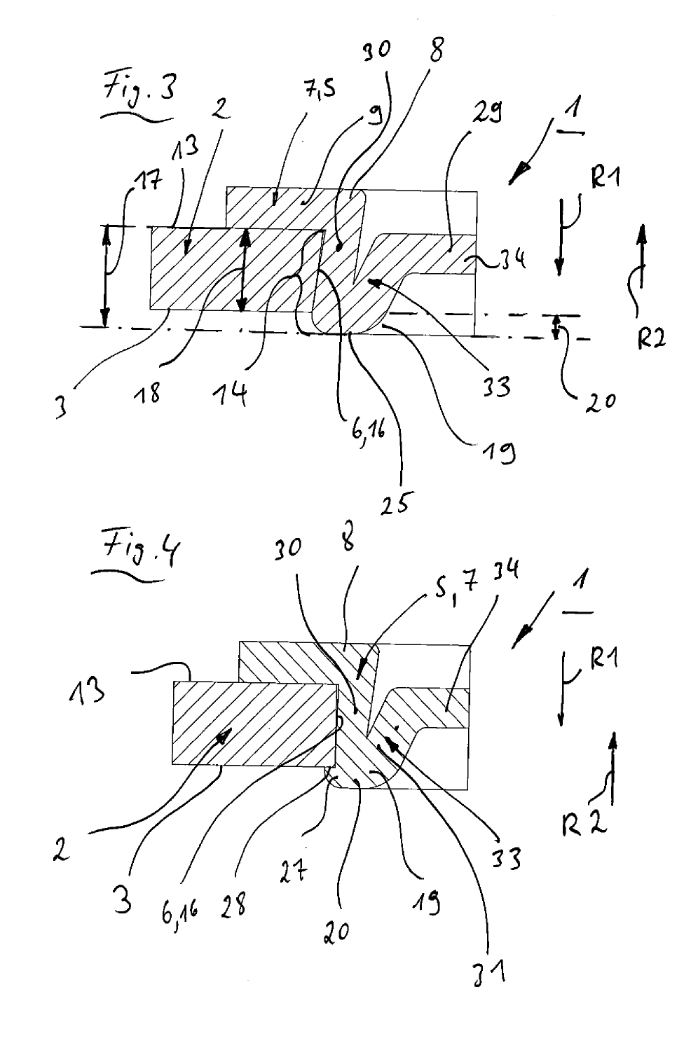

FIG. 4 shows an illustration corresponding to FIG. 3 which shows an alternative positive connection between the welding element and mounting part,

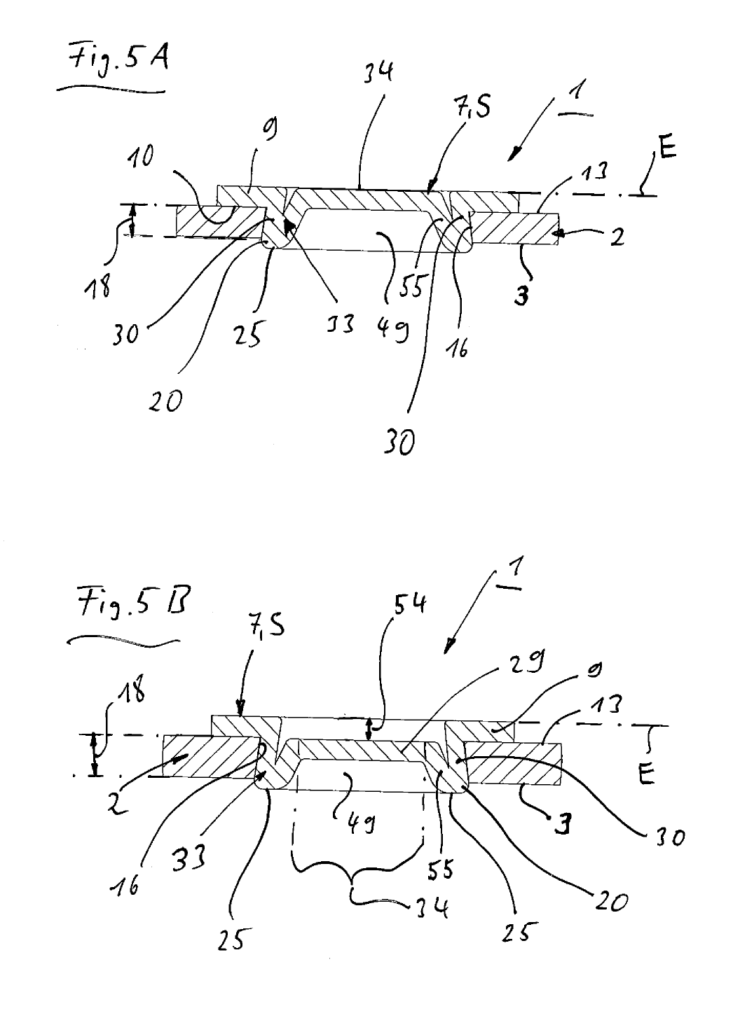

FIGS. 5A, B show an opposing positioning of two mounting units with mounting parts of different thicknesses,

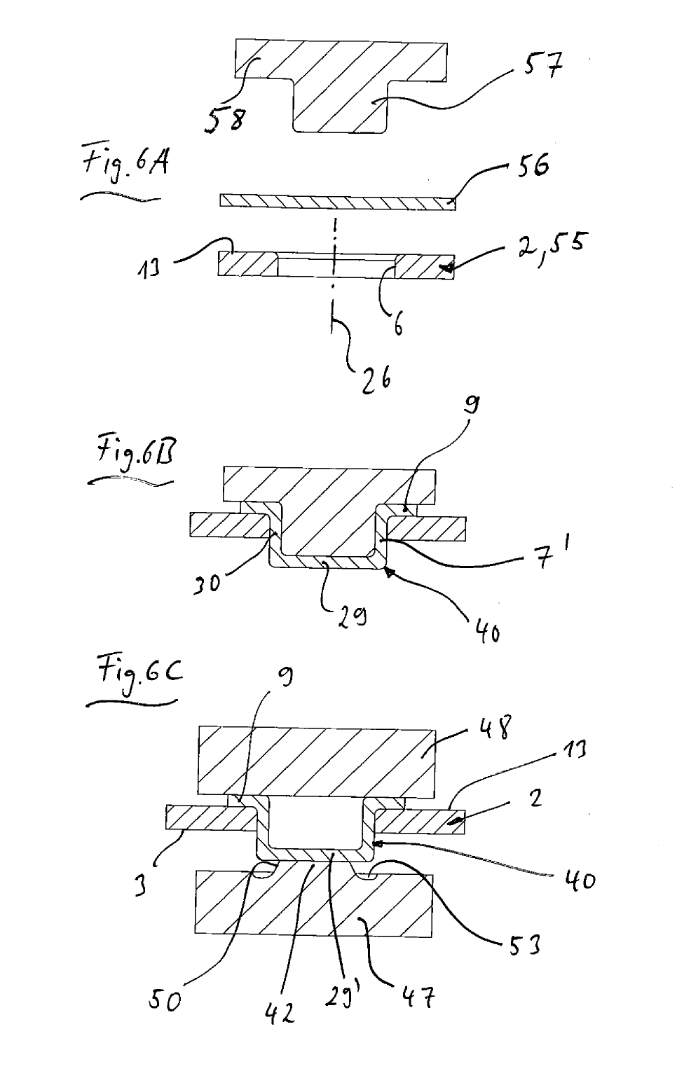

FIGS. 6A-6D show an alternative production method for the mounting unit according to FIG. 1A,

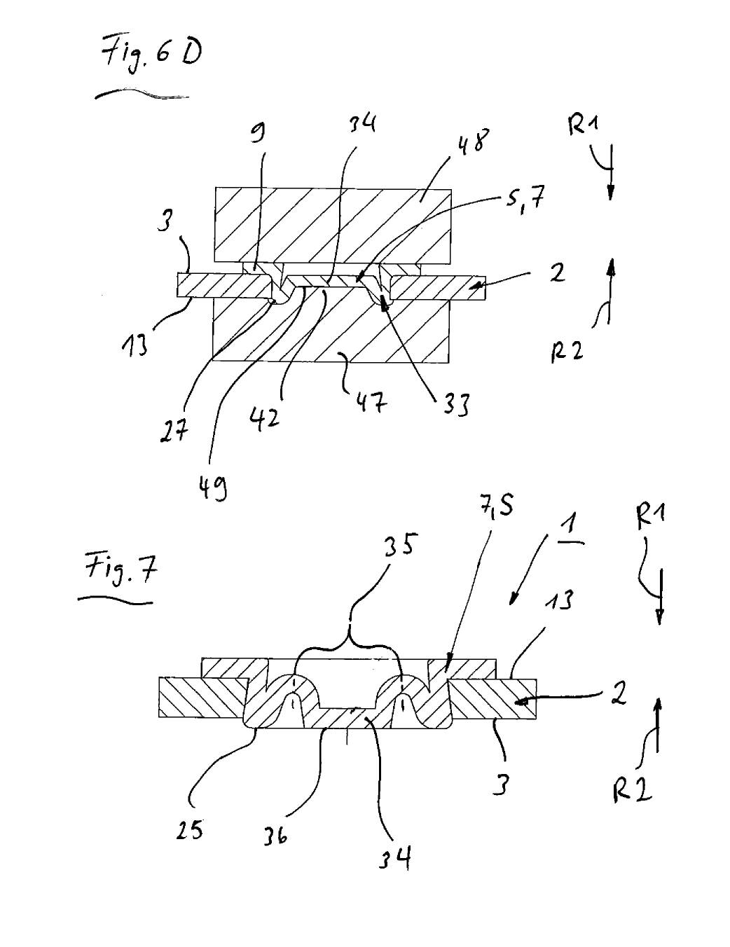

FIG. 7 show a variant of the exemplary embodiment of FIG. 1,

FIG. 8 shows a further variant of the exemplary embodiment of FIG. 1,

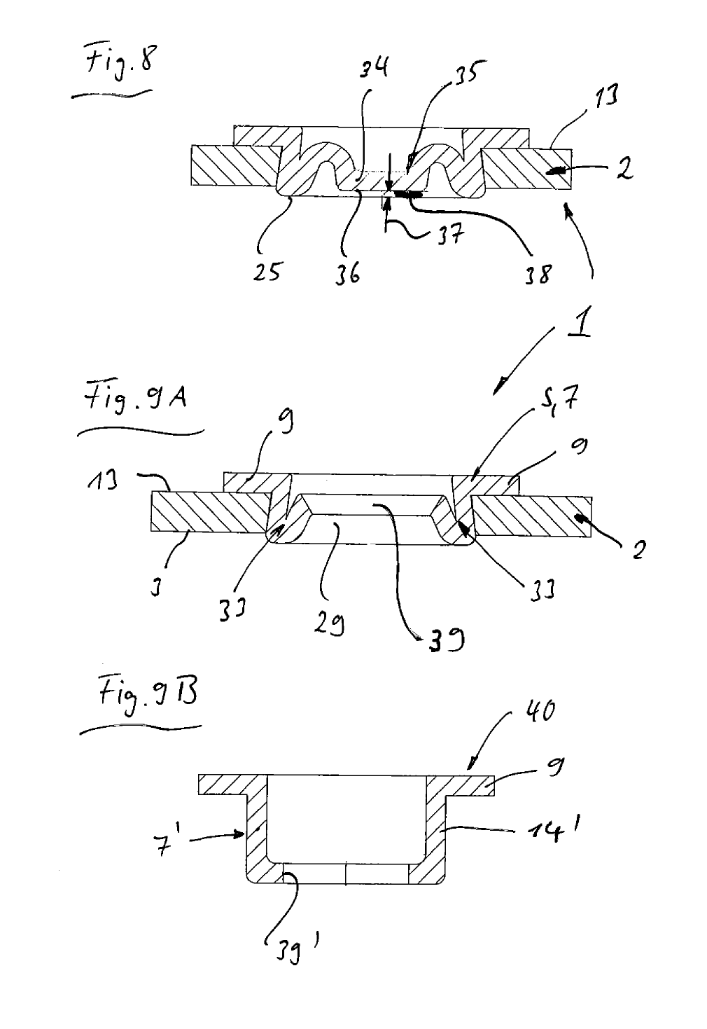

FIG. 9A shows a variant of the mounting unit of FIG. 1, which comprises a welding element with a central bore,

FIG. 9B shows the welding element blank for the mounting unit of FIG. 9A,

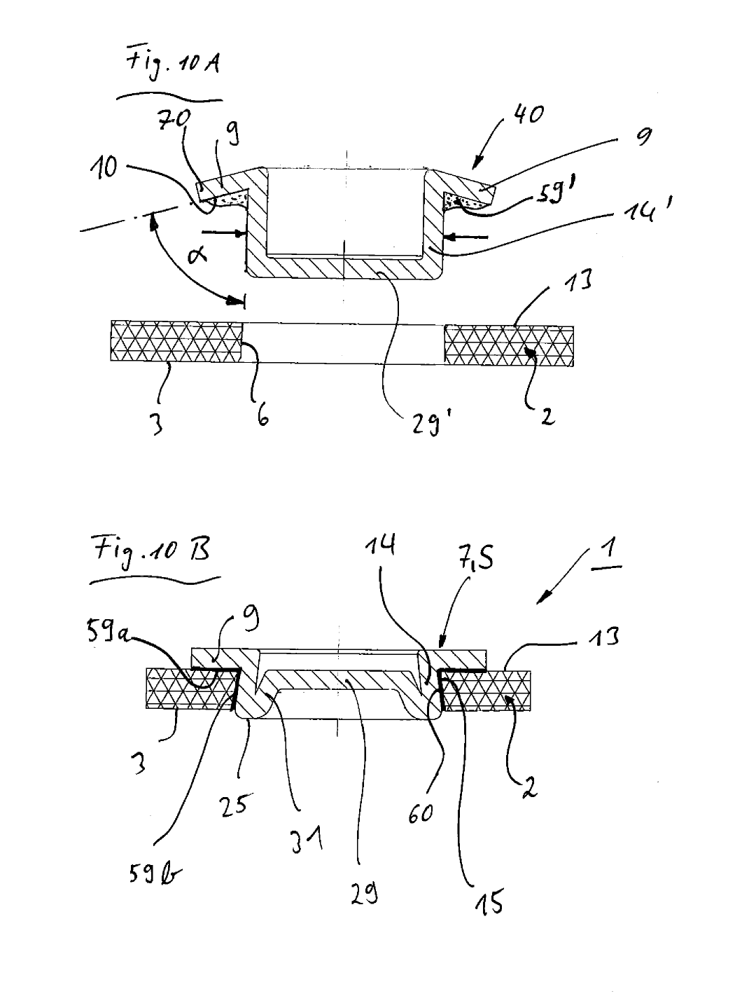

FIG. 10A shows the welding element blank and the mounting unit for a further variant of the mounting unit of FIG. 1,

FIG. 10B shows the finished mounting unit, i.e. the parts of FIG. 10A in the mounted state,

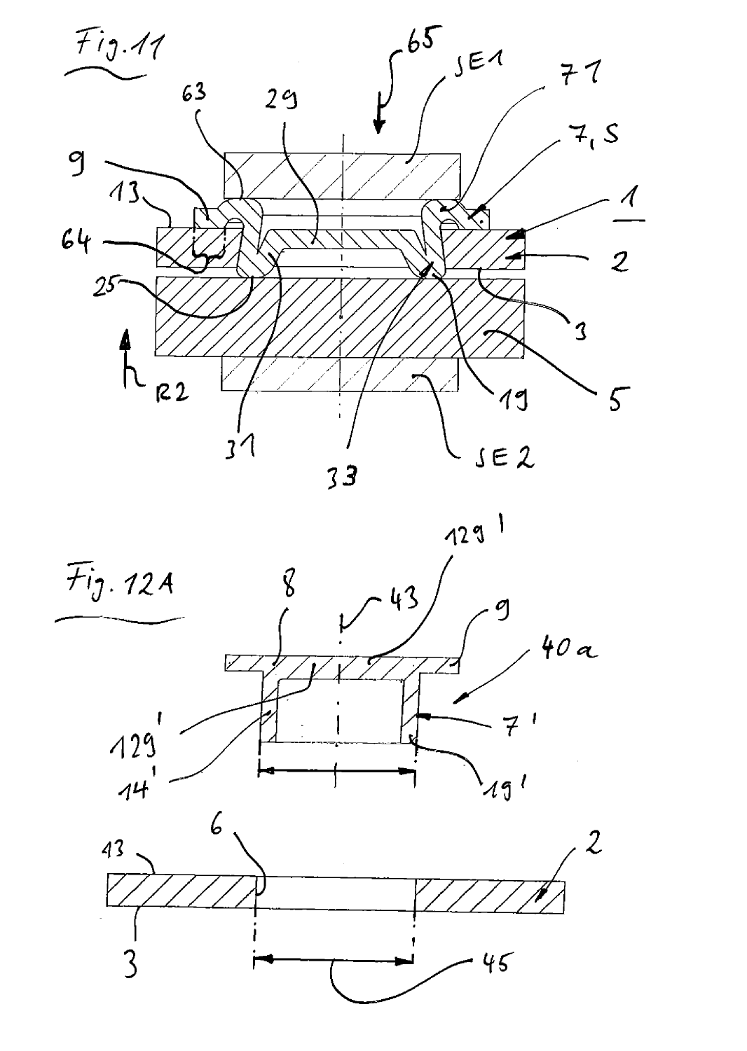

FIG. 11 shows the welding of a mounting unit to a basic structure by means of welding electrodes,

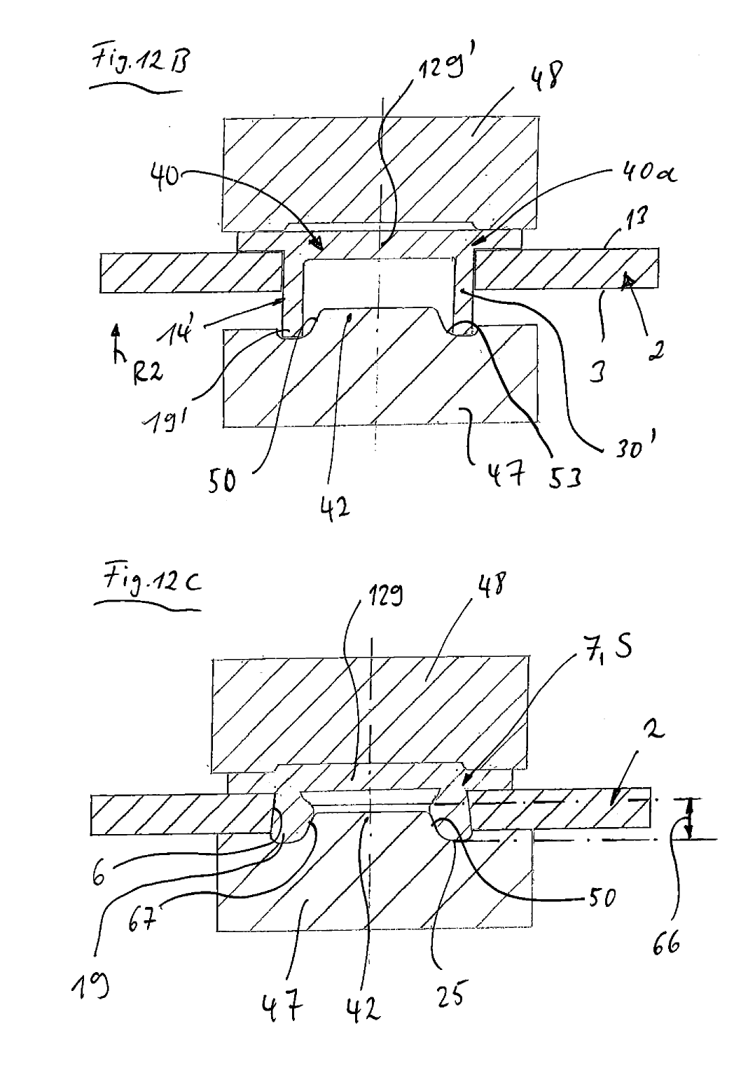

FIGS. 12A-12D show the production of a second exemplary embodiment of a mounting unit,

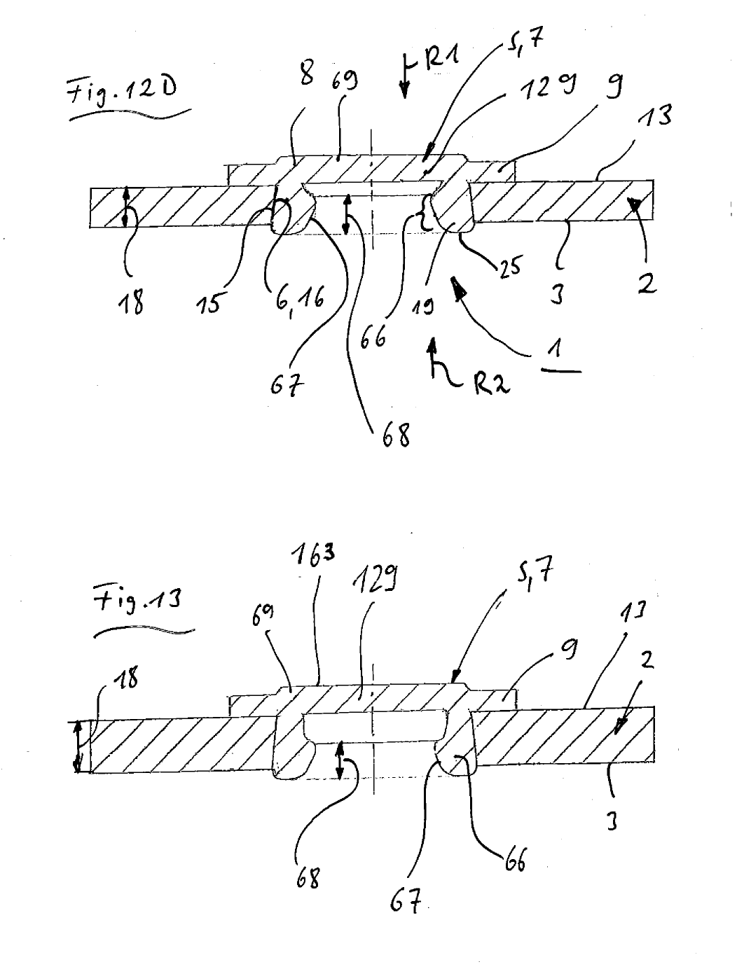

FIG. 13 shows a mounting unit corresponding to FIG. 12D but with a mounting unit of greater thickness,

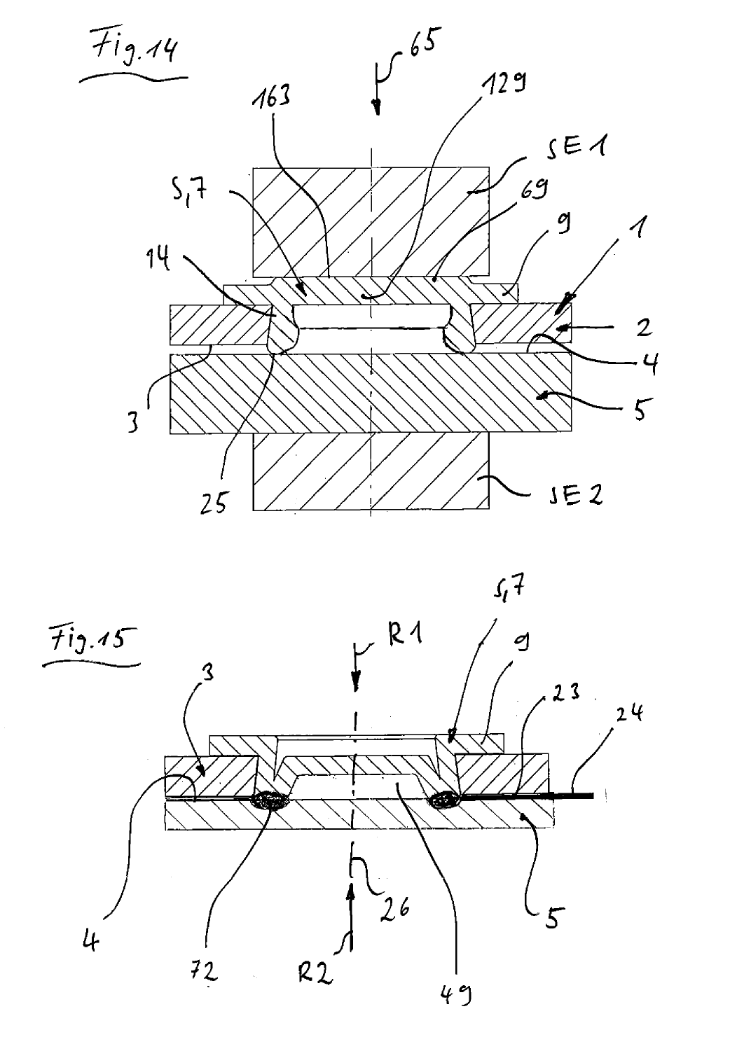

FIG. 14 shows the welding of a mounting unit according to FIG. 12D or FIG. 13B to a basic structure,

FIG. 15 shows a mounting unit welded to a basic structure.

The mounting units 1 shown in the illustrations comprise a mounting part 2 which, for example, is a sheet metal-like shaped part which is intended to be fixed to a basic structure 5 (FIG. 15) namely a frame structure of a motor vehicle or the like. The mounting part 2 has a mounting face 3 which in the final mounted state, i.e. when the mounting unit 2 according to FIG. 15 is welded to a mating surface 4 of the basic structure 5, faces the basic structure and/or the cited mating surface. The mounting part 2 is penetrated by a least one through-bore 6. A welding element S configured in the form of a sleeve 7 is positively fixed in the through-bore 6. The sleeve 7 has on its outer end 8 facing away from the mounting face 3, a radially protruding flange 9. Said flange extends transversely to the central longitudinal axis 26 of the through-bore 6 and/or the welding element S and with its flange lower face 10 bears fully, or as is the case in the mounting unit 1 of FIG. 11, partially against the outer face 13 of the mounting part 2. The outer face 13 extends at least in the edge region of the hole of the through-bore 6 parallel to the mounting face 3 and transversely to the aforementioned central longitudinal axis 26 and is remote from the mounting face 3. The part of the sleeve 7 extending away from the flange lower face, the shaft 14 thereof, extends into the throughbore 6 and has a contour shape which corresponds to the cross-sectional shape of the through-opening 6. In the exemplary embodiments shown in the illustrations, the through-bore 6 has a circular cross-sectional shape. The outer wall 15 of the shaft 14 bears substantially flat against the bore wall 16.

The length 17 of the shaft 14 is at least as great as the thickness 18 of the mounting part 2 in the edge region of the hole of the through-bore 6 (FIG. 3). If the shaft length 17 is greater than the thickness 18, the inner end 19 of the sleeve 7 and/or of the shaft 14 arranged in the region of the mounting face 3 protrudes with a set overhang 20 from the mounting face 3. The size of the aforementioned overhang is not arbitrary but is predetermined so that in the final mounted state according to FIG. 15 a defined intermediate space 23 is present between the mounting part 2 and the basic structure 5 in which, for example, an insulating layer 24 is arranged. Said insulating layer serves, for example, to prevent contact corrosion by preventing direct contact between the mounting part 3 and the basic structure 5 and the penetration of moisture in the intermediate space 23. An intermediate space 23 between the mounting part 3 and the basic structure 5, however, is not required in every case, for example when contact corrosion is not a risk. The inner end 19 of the sleeve 7 is then aligned virtually with the mounting face 3 so that for producing a welded connection the front face 25 present at the aforementioned end may be brought into contact with the mating surface 4 of the basic structure and may be welded thereto.

The positive fixing of the welding element S in the through-bore 6 takes place by means of two positive connections acting in opposing directions. Firstly, may be cited the flange 9 which bears against the outer face 13 of the mounting part 2 and/or radially overlaps the edge region of the hole of the through-bore 6 on the outer face. In this manner, a positive connection in a direction R1 extending parallel to the central longitudinal axis 26 of the through-bore 6 and extending toward the outer face 13 is ensured. In the final mounted state according to FIG. 15, the direction R1 faces at right angles to the mating surface 4 of the basic structure 5.

A second positive connection which is effective in a direction R2 opposing the direction R1 is achieved in that a portion of the bore wall 16 extending away from the mounting face 3 and the outer wall 15 of at least the inner shaft end 19 widens conically in a complementary manner toward the mounting surface 3 of the mounting part 2. This design of the positive connection is thus expedient if the material of the mounting part 3 has a lower hardness and/or is more easily deformable than the material of the welding element S. The positive connection may then be produced in a simple manner by at least the inner end 19 of the welding element S and/or of the originally cylindrical shaft 14′ of a welding element blank forming the subsequent welding element S, being substantially conically widened with a widening tool, wherein in this case the originally cylindrical bore wall 16 is plastically deformed by widening and at the end has a conical shape complementary to the conical deformation of the shaft 14.

A further possibility for producing a positive connection between the mounting part 2 and the welding element S in the direction R2 is that a radial outer region 27 of the inner shaft end 19 radially overlaps a rear engagement surface 28 of the mounting part 3, wherein the rear engagement surface 28 is remote from the outer face 13 of the mounting part 2 and extends transversely to the central longitudinal axis 26 of the through-bore 6 (FIG. 4). This type of positive connection is expedient if the material of the mounting part 2 has a greater hardness and/or is less easily plastically deformable than the material of the welding element S. When producing the mounting unit 1 the inner end 19 of the shaft inserted in the through-bore 6 is radially widened with a widening tool. This results substantially only in a plastic deformation of the shaft 14 such that the radial outer region 27 of the shaft 14 radially overlaps the rear engagement surface 28. In the exemplary embodiment shown in FIG. 4, the rear engagement surface is a region of the mounting face 3 extending away from the bore wall 16. Such a positive connection is also possible if no set overhang 20 of the shaft 14 is provided. The rear engagement surface 28 is then, for example, a radial shoulder inside the throughbore 6 (not shown).

The set overhang 20 is adjusted by an axial compression of the welding element. In the mounted state, therefore, an axially compressed welding element S is present, the shaft 14 thereof protruding with the set overhang from the mounting face 3 of the mounting part 2. The use of a more or less compressed welding element S has the advantage that, depending on the thickness 18 of a mounting part 2 to be connected to a basic structure 5, a single welding element blank 40, i.e. one with the same overall size and/or shaft length 17′, may be used. An initial overhang 46 of the welding element blank 40 (FIG. 2C) may be axially compressed by adapting to the respective thickness 18 of the mounting part 2 to such an extent that the inner end 19 of the shaft 14 in the mounted state protrudes with the set overhang 20 from the mounting face 3.

In the mounting unit of FIG. 1A, the inner end 19 of the shaft 14 is closed by a transverse wall 29. An edge region of the transverse wall 29 forms with the sleeve wall 30 a V-shaped fold 33 opening toward the outer sleeve end 8. The front face 25 which serves as a welding surface is arranged on the connecting region between the sides of the fold 33 arranged in a V-shape. The central region 34 of the transverse wall 29 located radially inside the fold 33 extends in the exemplary embodiment of FIG. 1A in a plane parallel to the mounting face 3 of the mounting part 2. The welding element S is in an axially compressed state. On its side remote from the outer face 13 of the mounting part 2, a depression 49 is present, said depression being surrounded by the central region 34 and the fold 33.

In the variant of FIGS. 7 and 8 the central region 34 of the transverse wall 29 does not extend in one plane but is in the shape of a dish 35 opening toward the outer face 13 of the mounting part. The lower face 36 of the bottom of the dish remote from the outer face 13 of the mounting part 2 is aligned with the front face 25 of the sleeve 7 and forms an additional welding surface by which the welding element S may be welded to the mating surface 4 of the basic structure 5. In the variant of FIG. 8, the central region 34 of the transverse wall 29 is also configured in the form of a dish 35. The lower face 36 of the dish, however, is also set back in the direction of the outer face 13 of the mounting part 2, so that an axial spacing 37 is present between the plane spanned by the front face 25 of the sleeve 7 and the lower face 36. In the final mounted state according to FIG. 15, by means of the spacing 37, an intermediate space (not shown) is kept free, said intermediate space serving, for example, for receiving a layer of adhesive 38 (FIG. 8). In the variant of FIG. 9A, the transverse wall 29 is penetrated by a central bore 39. Only one radial external region of the transverse wall 29 is present, said radial external region forming the radial inner side of the fold 33. A central region 34 of the above-mentioned type is thus not present.

During the production of a mounting part 1 initially a sleeve 7′ is provided as a welding element blank 40. The sleeve 7′ corresponds substantially to the subsequent sleeve 7 of the finished mounting part 1. The sleeve wall 30′ thereof is not yet radially widened, and thus still has the original cylindrical shape. The flange 9 already described above is integrally formed on the outer end 8 thereof. The subsequent inner end 19 of the sleeve 7′ is closed by a transverse wall 29′ which extends in a plane extending transversely to the central longitudinal axis 43 of the welding element blank. A mounting part 2 which is penetrated by at least one through-bore 6 is provided. The through-bore 6 has a circular cylindrical cross-sectional shape, wherein the diameter 45 thereof is slightly greater than the outer diameter 44 of the shaft 14′. The shaft 14′ may thus be easily inserted into the through-opening 6. At the end of the insertion process, the flange 9 bears with its flange lower face 10 against the outer face 13 of the mounting part 2 (FIG. 2C). The length 17′ of the shaft 14′ is dimensioned such that the shaft 14′ protrudes with an overhang 46 from the mounting face 3 of the mounting part 2.

As the next method step, generally a widening and plastic deformation of a partial region and/or axial portion of the shaft 14′ extending away from the inner end 19 is undertaken by means of a widening tool, namely the punch 47 supplied from the mounting face 13. The result of this measure is a positive connection between the radially widened shaft 14 and the mounting part 2 in a direction R2 facing toward the mounting face 13. In the case shown in FIGS. 2A-D, the subsequent inner end 19 of the shaft 14′ is closed by a transverse wall 29′. According to FIG. 1A a punch 47 is used to form a mounting unit 1, said punch having a central circular projection 42 with a conically extending side wall 50 and being surrounded by an annular recess 53. The projection 42 and the recess 53 surrounding said projection together form a punch surface which is complementary to the side of the welding element 7, S remote from the outer face 13 of the mounting part.

By the cooperation of a counter holder 48 applied to the flange 9, a central region of the transverse wall 29′ is forced by the projection 42 into the interior of the sleeve 14′, wherein at the same time due to the conical side wall 50 of the projection 42 the sleeve 7′ is radially widened and the initial overhang 46 is shortened to the set overhang 20. The extent of the respective shortening of the initial overhang 46 is dependent on the thickness 18 of the mounting part 2. The thinner the mounting part 2, the further the transverse wall 29′ of the welding element blank 40 is pressed by the punch 47 toward the plane E spanned by the flange 9 and the deeper the side of the transverse wall 29 remote from the outer face 13 of the mounting part 2, through the depression 49 produced by the plastic deformation under discussion. In the mounting unit 1 of FIG. 5B with the thicker mounting part 2 an axial spacing 54 is present between the plane E and the transverse wall 29 and/or the central region 34 thereof. Conversely, in the mounting unit 1 of FIG. 5A with the thinner mounting part 2 the central region 34 of the transverse wall 29 is aligned with the plane E. The difference in thickness between the mounting parts 2 is thus compensated by means of the fold 33 formed by the axial compression of the welding element blank 40: with the reducing thickness 18 of the mounting part 2, the length of the side 55 of the fold located radially on the inside increases until it has the same length as the side of the fold 33 located radially on the outside, formed by the sleeve wall 30 corresponding to the state according to FIG. 5A.

In the example shown in FIGS. 2A-D the material of the mounting part 2 is more flexible and thus more deformable than the material of the welding element blank 40. Accordingly, the bore wall 16 is deformed in a complementary manner to the conical widening of the sleeve wall 30, which may be clearly derived from FIG. 3. If the mounting part consists of a material which is harder and/or harder to deform plastically than the welding element S, an alternative production method is provided as may be derived from FIGS. 6A-D. Due to the aforementioned difference in hardness, the region of a mounting part 2 having the through-bore 6 may be used as a drawing die 55 for producing the welding element blank 40 from a sheet metal blank 56. To this end, the sheet metal blank 56 is pressed onto the through-opening 6 and namely concentrically to the central longitudinal axis 26 thereof and by means of a deep drawing punch 57 a radial internal region of the sheet metal blank 56 is pressed through the through-opening 6, forming the sleeve wall 30 and the transverse wall 29′ of the welding element blank 40. The flange 9 of the welding element S is formed from a radial external region of the sheet metal blank 56, wherein said flange is pressed by a flange-like radially protruding part 58 of the deep drawing punch 57 flat against the outer face 13 of the mounting part 2. In this variant of the method, therefore, the shaping of the welding element blank 40 and the insertion thereof into the through-bore 6 take place in a single method step.

The plastic deformation of the welding element blank 40 for the purpose of the positive connection with the mounting part 2 takes place according to FIG. 6C, i.e. as in the above described manner (see description of FIGS. 2C and 2D). However, due to the harder material of the mounting part 2 the bore wall 16 of the through-bore 6 is not conically widened. Instead, the radial outer region 27 of the inner shaft end 19 of the welding element S is forced radially outwards by the punch 47, wherein it radially overlaps the mounting surface 13 acting as a rear engagement surface 28, forming the positive connection acting in the direction R2 (see also FIG. 4).

The production of the variant FIG. 9A may take place in the same manner as described above. Only one welding element blank 40 is used, the transverse wall 29′ thereof, as shown in FIG. 9B, being penetrated by a central bore 39′. The above-described production method may also be used for the variant according to FIGS. 7 and 8. However, for the shaping of the dish 35 opening toward the outer face 13 of the mounting part 2, a [ ] with a complementary shaped projection (not shown) and a punch 47 with a corresponding recess (not shown) are required.

In FIG. 10B a mounting unit 1 is shown in which an insulating layer 59a is present between the flange 9 and the outer face 13 of the mounting part 2 and/or on the flange lower face 10 in order to prevent, for example, contact corrosion. Such an insulating layer 59b may also be present in a gap between the shaft 14 of the sleeve 7 and the bore wall 16 and/or on the outer wall 15 of the shaft 14. An insulation of this type is expedient, in particular, in a mounting part which consists of carbon fiber reinforced plastics. This material—carbon fiber reinforced plastics—behaves electrochemically as a precious metal.

For producing a mounting unit 1 with an insulating layer 59a and/or 59b, for example the corresponding surfaces of the welding element blank 40, i.e. for example the flange lower face 10 and the shaft 14, may be provided with a corresponding coating. If, however, such a welding element blank 40 is inserted into the through-bore of the mounting part 2, there is the risk that insulating material present on the outside of the shaft 14′ is at least partially abraded again. In order to avoid this, a welding element blank 40 is used, the flange lower face 10 thereof forming with the outer wall 15 of the shaft 14′ an acute angle a. An insulating material 59′ is applied to the flange lower face 10 in a quantity which is larger than is required for forming the subsequent insulating layer 59a between the flange 9 and the mounting part 2. When pressing the blank 40 using a method according to FIGS. 2A-D, initially the outer edge 70 of the flange 9 comes to bear against the outer face 13 of the mounting part 2. If the flange 9 in the continuation of the production method is pressed with its flange lower face 10 against the outer face 13 and at the same time is deformed such that it extends in a [ ] transversely to the central longitudinal axis 26 of the through-bore, the insulating material 59″ is pressed on the flange lower face 10 into a gap 60 present between the shaft 14 and the bore wall 16, forming the insulating layer 59b. So that a gap 60 is present with a corresponding receiving capacity for the insulating material 59′, the external diameter 44 of the shaft 14′ and the diameter 45 of the through-bore 6 are adapted to one another accordingly.

The welding of a mounting unit 1, and/or a welding element S,7 connected to a mounting part 2, to the basic structure 5 takes place by means of a first welding electrode SE1 applied to the flange side of the welding element, and a second welding electrode SE2 (FIG. 11 and FIG. 14) in contact with the basic structure. The contact surface 63 present on the flange side, with which the first welding electrode SE1 is in electrical contact with the welding element S,7, has a larger surface than the front face 25 of the inner end 19 of the welding element which serves as a welding surface, i.e. is welded to the basic structure. By means of the cited surface ratio it is ensured that a high flow density prevails in the region of the front face 25 so that the metals may be melted and welding may take place in the region of the front face 25.

In the example shown in fig. lithe contact surface 63 is present on an annular bead 71 of the flange 9. The annular bead 71 is a region of the flange 9 which has been bulged outwardly in the direction R2. In contrast to the variant of FIG. 1A, only one partial region 64 of the flange 9 extending radially outwardly away from the annular bead 71 bears against the mounting face 13 and/or the edge region of the hole of the through-bore 6, but not the lower face of the annular bead 71. The effect of this design is that none of the welding current or at least only a small proportion of the welding current flows via the mounting part 2 and thus the edge region of the hole, located in plan view according to the arrow 65 below the flange 9, does not heat up as much.

In the above-described welding element S,7, the inner end 19 of the shaft 14 is at least partially closed by a transverse wall 29. In a further variant, a transverse wall 129 is present on the outer end 8 of the shaft 14 (FIG. 12D). In this case the transverse wall 129 protrudes radially beyond the shaft 14, forming the flange 9. As in the variant described further above, with the internal transverse wall 29, the welding element is fixed to the mounting part 2 and/or in the through-bore due to the flange radially overlapping the edge of the through-bore and by a first positive connection in the direction R1.

Also the second positive connection acting in the direction R2 is effected in the same manner as in the first variant. To this end, at least the inner end 19 of the sleeve 7 and/or the welding element S is radially widened, wherein a positive connection is present corresponding to FIG. 3, if the welding element S,7 relative to the mounting part 2 consists of a harder, less easily deformable material. At least one longitudinal portion of the shaft 14 adjacent to the front face 25 is radially widened wherein the outer wall 15 and/or the aforementioned longitudinal portion thereof is conically formed. The bore wall 16 cooperating with the outer wall and/or a longitudinal portion thereof is deformed in a complementary manner. When the mix of materials is reversed, however, a positive connection is present according to FIG. 4.

The production of a mounting unit 2 with a welding element S,7 with an outer transverse wall 129 takes place as FIGS. 12B and 12C show, principally in the same manner as described further above. The radial widening of the inner end 19′ of the welding element blank 40 takes place by means of a punch 47 of the type shown in FIGS. 2C and 6C. Said punch also comprises a projection 42 with a conical side wall 50 and an annular recess 53 surrounding the projection. The counter holder 48 required for axial compression of the welding element blank 40, bears at least flat against the flange 9. If the punch 47 and the counter holder 48 are moved in a relative manner toward one another, the shaft 14′ of the aforementioned blank 40 is axially compressed. In this case, due to the conical side surface 50 of the projection 42 in addition to the axial compression a radial widening of the inner end 19′ of the shaft 14′ takes place, forming the positive connection which is effective in the direction R2. The sleeve wall 30′ of the welding element blank 40 is in this case thickened as a result of the compression. The longitudinal portion of the sleeve wall 30 adjacent to the front face 25 of the welding element S,7 of the mounting unit 1 forms a thickened region 66, the inner wall thereof 67 being shaped in a complementary manner to the conical side wall 50 of the punch projection 42.

During the production of the mounting unit 1 under discussion, a welding element blank 40 which is suitable for mounting parts 2 of variable thicknesses 18 is also used. The axial extent 68 of the thickened region 66 is smaller, the greater the thickness 18 of the mounting part 2. Thus in the mounting unit 1 of FIG. 12D with the thinner mounting part 2 the aforementioned axial extent 68 is greater than in the mounting unit 1 of FIG. 13 with a thicker mounting part 2.

The welding of a mounting unit according to FIG. 12D and FIG. 13 takes place once again using two welding electrodes SE1, SE2 (FIG. 14). The contact surface 163 with which the welding element S,7 is brought into contact with the first welding electrode, placed on the flange side thereof, is once again larger than the front face 25 of the shaft 14. Moreover, the contact surface 163 protrudes in a domed manner from the side of the transverse wall 129 remote from the mounting part 2, wherein it is formed by the surface of a disk-shaped projection 69 of the transverse wall 129. The projection does not overlap the edge of the through-bore 6 so that the welding current is not conducted via the edge region of the hole to the welding face and/or front face 25. The edge region of the hole of the mounting part 2 arranged below the flange 9, viewed in the direction of the arrow 65, is not subjected to as much heating as a result.

FIG. 15 shows a mounting unit in the final mounted state in which it is welded to the mating surface 4 of a basic structure 5 by means of the welding element S,7. The indirect connection of the mounting part 2 to the basic structure 5 results, on the one hand, from the radial overlap of the flange 9 of the welding element S,7 in the edge region of the hole of the through-bore 6 and, on the other hand, from the welded connection 72 of the front face 25 of the welding element S,7 with the mating surface 4 of the basic structure 5. A material layer is present in the intermediate space 23 between the mounting part 2 and the basic structure 5, said material layer for example acting as an insulating layer 24, for example for avoiding contact corrosion, and/or as an adhesive layer for increasing the load-bearing capacity.

### LIST OF REFERENCE NUMERALS

1 Mounting unit
2 Mounting part
3 Mounting face
4 Mating surface
5 Basic structure

### 6 Through-bore

### 7 Sleeve

### 8 Outer end (of 7)

### 9 Flange

10 Flange lower face
13 Outer face

### 14 Shaft

15 Outer wall (of 14)
16 Bore wall

### 17 Length (of 14)

### 18 Thickness (of 2)

### 19 Inner end (of 7)

20 Set overhang
23 Intermediate space
24 Insulating layer
25 Front face
26 Central longitudinal axis
27 Radial outer region (of 7)
28 Rear engagement surface
29 Transverse wall
31 Inner face (of 29)
30 Sleeve wall

### 33 Fold

34 Central region (of 29)

### 35 Dish

36 Lower face

### 37 Spacing

38 Adhesive layer
39 Central bore
40 Welding element blank

### 42 Projection (on 47)

43 Central longitudinal axis (of 40)
44 Outer diameter (of 7′)

### 45 Diameter (of 6)

### 46 Overhang

### 47 Stamp

48 Counter holder

### 49 Depression

### 50 Shaft

### 53 Recess

54 Axial spacing

### 55 Drawing die

56 Sheet metal blank
57 Deep drawing punch

### 58 Part (of 53)

59 Insulating layer

### 60 Gap

63 Contact surface
64 Partial region

### 65 Arrow

66 Thickened region (of 14)
67 Inner wall
68 Axial extent

### 69 Projection

70 Outer edge
71 Annular bead
72 Welded connection
129 Transverse wall
163 Contact surface
S Welding element

### R1 Direction

R2 Direction

1-19. (canceled)

20. A mounting unit, comprising:
a mounting part having a mounting face and an outer face facing away from said mounting face, said mounting part configured for fixing to a mating surface of a basic structure made of a material which is not able to be welded to a material of said mounting part, said mounting part having a through-bore formed therein; and
a welding element configured as a sleeve and fixed in said through-bore of said mounting part, said sleeve having an outer end disposed on said outer face and bearing a radially protruding flange supported on said outer face of said mounting part and having a flange lower face, said sleeve having a shaft protruding from said flange lower face and having a contour shape corresponding to a cross-sectional shape of said through-bore and a length being at least as large as a thickness of said mounting part in an edge region of said through-bore, said shaft being retained in said through-bore by a form-locking connection in a direction facing toward said mounting face, said shaft having an inner end disposed on said mounting face and said inner end having a front face serving as a welding surface for welding to the mating surface of the basic structure.

21. The mounting unit according to claim 20, wherein said shaft of said sleeve protrudes beyond said mounting face of said mounting part with a set overhang.

22. The mounting unit according to claim 20, wherein:
said mounting part has a bore wall; and
said inner end has an outer wall, and for forming the form-locking connection, at least one longitudinal portion of said bore wall extending away from said mounting face and said outer wall of at least said inner end of said shaft widens conically toward said mounting face.

23. The mounting unit according to claim 20, wherein:
said mounting part has a rear engagement surface; and
said inner end of said shaft has a radial outer region, and for forming the form-locking connection said radial outer region of said inner end radially overlaps said rear engagement surface of said mounting part extending transversely to a central longitudinal axis of said through-bore and facing the basic structure.

24. The mounting unit according to claim 23, wherein said rear engagement surface is an edge region defining said through-bore on a mounting side.

25. The mounting unit according to claim 20, wherein said inner end of said shaft protrudes with a predetermined set overhang from said mounting face of said mounting part.

26. The mounting unit according to claim 20, wherein:
said sleeve has a transverse wall; and
said outer end of said sleeve is closed by said transverse wall.

27. The mounting unit according to claim 26, wherein said transverse wall protrudes radially beyond said shaft, forming said flange.

28. The mounting unit according to claim 20, wherein said sleeve has a transverse wall and a further wall, said inner end of said shaft is closed at least partially by said transverse wall, an edge region of said transverse wall forms with said further wall of said sleeve a V-shaped fold opening toward said outer end.

29. The mounting unit according to claim 28, wherein a side of said transverse wall facing in a same direction as said mounting face of said mounting part has a central region forming a further welding surface which is able to be welded to the mating surface of the basic structure.

30. The mounting unit according to claim 29, wherein said further welding surface formed by said central region is aligned with a front face present on said inner end of said shaft.

31. The mounting unit according to claim 20, further comprising an insulating layer, said lower face of said flange bears said insulating layer.

32. The mounting unit according to claim 31, wherein said insulating layer is present on an outer wall of said shaft.

33. A method for producing a mounting unit, which comprises the steps of:
providing a mounting part having a mounting face and an outer face facing away from the mounting face, the mounting part configured for fixing to a mating surface of a basic structure made of a material which is not able to be welded to a material of the mounting part, the mounting part having a through-bore formed therein;
providing a sleeve functioning as a welding element blank and having an end bearing a radially protruding flange, wherein a shaft of the sleeve protruding from a flange lower face and having a contour shape corresponding to a cross-sectional shape of the through-bore and a length which is at least as large as a thickness of the mounting part in an edge region defining the through-bore;
introducing the welding element blank into the through-bore such that the radially protruding flange at least partially bears against the outer face of the mounting part and an inner end of the shaft on a mounting side is aligned with the mounting face or protrudes therefrom with an overhang; and
radially widening, by means of a punch supplied from the mounting face, at least one longitudinal portion of the shaft extending away from the inner end and at the same time is plastically deformed, forming a form-locking connection between the shaft and the mounting part in a direction facing toward the mounting face.

34. The method according to claim 33, which further comprises performing the radially widening of the shaft such that at the same time a bore wall of the mounting part and at least the longitudinal portion are plastically deformed, forming in each case a cone surface widening toward the mounting face.

35. The method according to claim 34, which further comprises performing the radially widening step such that a radial outer region of the inner end of the welding element blank radially overlaps a rear engagement surface of the mounting part extending transversely to a central longitudinal axis of the through-bore and facing away from the outer face of the mounting part.

36. The method according to claim 35, wherein the rear engagement surface is a region of the mounting face extending away from the bore wall.

37. The method according to claim 35, wherein a shaping of the welding element blank and an insertion thereof into the through-bore take place in a single method step, by a sheet metal blank being positioned on the through-bore and a radial internal region of the sheet metal blank forming the shaft of the welding element blank being pressed through the through-bore by means of a deep drawing punch, wherein a radial external region of the sheet metal blank forms the radially protruding flange.

38. The method according to claim 33, which further comprises forming the overhang larger than a set overhang with which the welding element protrudes from the mounting face in a subsequent mounting state in which the welding element is fixed in the through-bore of the mounting part, with a final strength which has been provided, wherein the set overhang is adjusted by an axial compression of the welding element blank.
